(19) United States
(12) Patent Application Publication
(10) Pub. No.: US 2006/0144328 A1
(43) Pub. Date: Jul. 6, 2006

(54) Device for applying a homogeneously thick liquid layer over the working width of a material web

(76) Inventor: Gerold Fleissner, Zug (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/535,957

(22) PCT Filed: Nov. 20, 2003
(86) PCT No.: PCT/EP03/50857

§ 371 Date: Nov. 8, 2005

(30) Foreign Application Priority Data
Nov. 22, 2002 (DE) 102 54 793.9

(51) Int. Cl. B05C 5/00; B05C 11/10

(52) U.S. Cl. 118/300; 118/501

(57) ABSTRACT

In paint application devices that work on the pouring principle, it is known to collect the liquid flowing over a spillover weir in an upstream liquid reservoir. The liquid then flows over the spillover weir and over the guide surface extending downstream therefrom. When large application quantities of 50 l/m/min and more are involved, there is a risk that the liquid film may become separated from the guide surface in the area of the spillover weir. It is intended to coat this spillover weir over the entire working width thereof by using a height-adjustable diverter block with a downwardly protruding lip to regulate the volume of liquid that flows down onto the guide surface.

The invention relates to a device for applying a wide liquid film that is in laminar flow in even thickness over its working width to a continuously advancing strip of goods, having a liquid reservoir that is restricted on one side by a deflector vane that is inclined upwards at an angle to the horizontal and extends the entire working width, which is followed in the downstream direction by a spillover weir and a guide surface connected thereto, from the bottom edge of which the overflowing liquid film runs off onto the strip of goods, and which is preferably restricted on the other side by an opposing deflector vane disposed above the first deflector vane and with a space therebetween, the liquid reservoir having a liquid inflow area.

A device of such kind is known from European Patent No. EP-A-0 753 357. A characterizing feature of that device is that the liquid is applied evenly to strip of goods as it advances. This is true initially for any quantity of a paint to be applied. However, it has been shown for larger quantities that with necessarily thick liquid films the pressure from the feed pumps must be so great that the liquid becomes separated from the surface at the spillover weir. The liquid overshoots the spillover weir, and it is no longer possible to apply the liquid evenly over the working width of the guide surface. This problem of constantly increasing kinematics to counter the effective gravity was observed for application quantities between 50 and 200 l/m/min. Of course, it also applies for larger application quantities.

The task underlying the invention is to improve an application device of the kind described in the introduction so that any volume may be distributed evenly over the working width in a given time unit.

To solve this task, it is provided according to the invention that a diverter block extending over the entire working width be attached to the spillover weir or the guide surface to limit the flow rate. The effect of this diverter block is to slow and deflect the liquid rushing towards the spillover weir, thus forcing it to run down on the guide surface at a thickness that is predetermined via the adjustable diverter block.

According to European Patent No. EP-A-0 753 357, a divider comb is arranged inside the liquid reservoir and is designed to have a calming and homogenizing effect on the liquid as it flows towards the spillover weir. In conjunction with the diverter block provided according to the present invention, which limits the film thickness of the flow area over the entire working width, it is also advantageous if the free ends of this comb are curved in such manner that they extend over the spillover weir and down to the level of the guide surface.

The drawing is an exemplary illustration of a device according to the invention. In the drawing:

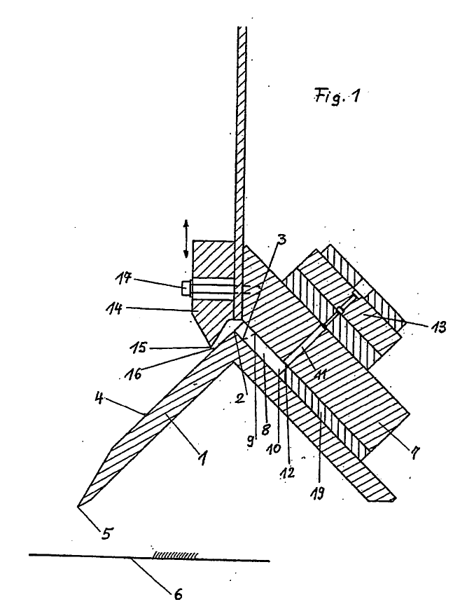

FIG. 1 is a cross-section through the beam of the liquid application mechanism with the diverter block attached to the beam,

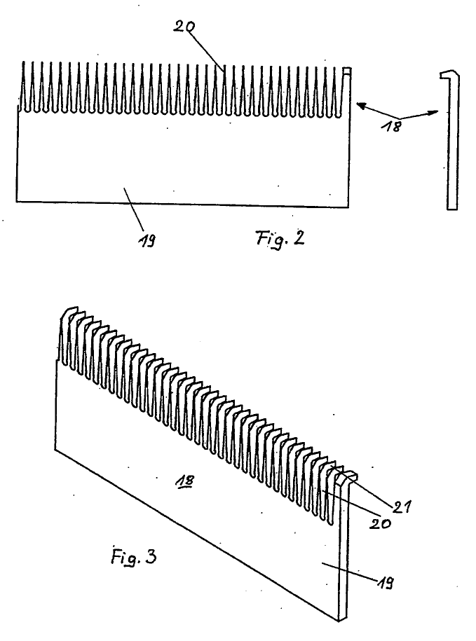

FIG. 2 is a front view and cross-section of a divider comb arranged inside the liquid reservoir and

FIG. 3 is a perspective view of the divider comb.

The liquid application device as shown in FIG. 1 includes an angled beam 1, on which spillover weir 2, which describes a 90° angle, is oriented upwards. The leg that is inclined upwards towards the spillover weir 2 is deflector vane 3, to which guide surface 4 is attached after spillover weir 2. The liquid film or layer for application flows in even distribution down this guide surface, and having flowed off the bottom edge 5 of guide surface 4, it is distributed on the strip of goods 6.

A massive member 7, the liquid distribution mechanism, is is attached in liquid-impermeable manner to the side of beam 1 opposite deflector vane 3, and includes a liquid reservoir 8 in the area adjacent spillover weir 2. This liquid reservoir 8 is delimited initially by deflector vane 3, and the opposing deflector vane 9 of the liquid distribution element, which is arranged above and at a distance from the first deflector vane, and extends parallel thereto.

The liquid collecting area 10 is situated at the end of the liquid reservoir 8 opposite spillover weir 2. It includes a plurality of boreholes 11 that pass through liquid distribution mechanism 7, and have liquid inflow apertures 12 at the lower end of the liquid reservoir 8.

A liquid distribution mechanism 13 as described in German Patent No. DE 40 26 198 A1 is arranged at the opposite, upper end of boreholes 11.

It is normally sufficient if the stream of liquid that is pumped through boreholes 11 flows to spillover weir 2 and from there flows downwards over guide surface 4. However, with large application quantities of 50 l/m/min. and more there is a risk that the liquid distributed over the working width of the application device may flow so quickly that the kinematics exceed the force of gravity at spillover weir 2. With such large quantities of liquid, it may happen that the liquid rushes uncontrollably over spillover weir 2. To prevent this, a liquid diverter block 14 that restrains the incoming liquid is introduced over the length of the application device in the area of the spillover weir. It has a bottom lip 15, which together with guide surface 4 forms a flow gap 16. By this means, the advancing volume of liquid is forced to follow the path over spillover weir 2, it collects in front of flow gap 16 and then flows with the desired thickness and in the desired volume along guide surface 4 over the entire width of the application device and onto the goods 6.

Of course, the height of liquid diverter block 14 is adjustable via screws 17 that engage with member 7.

A divider comb 18 is arranged inside liquid reservoir 8, and the lower mounting rail 19 thereof closes off the bottom the liquid reservoir 8. It is advantageous if the free ends 20 of divider comb 18 are shaped to curve downwards, as is apparent in FIGS. 2 and 3. The curves at the ends rest on spillover weir 2. This curved shape of the comb ends 21 guides the liquid around spillover weir 2 and assists with the guidance of the application liquid on to guide surface 4.

1. A device for applying a wide liquid film that is in laminar flow in even thickness over its working width to a continuously advancing strip of goods, having a liquid reservoir that is restricted on one side by a deflector vane that is inclined upwards at an angle to the horizontal and extends the entire working width, which is followed in the downstream direction by a spillover weir and a guide surface subsequent thereto, from the bottom edge of which the overflowing liquid film runs off onto the strip of goods, and which is preferably restricted on the other side by an opposing deflector vane disposed above the first deflector vane and with a space therebetween, wherein the liquid reservoir has a liquid inflow area characterized in that a diverter block (14) that restricts the flow quantity is attached to the spillover weir (2) and/or the guide surface (4) over the entire working width, and arranged at a distance therefrom.

2. The device as cited in claim 1, characterised in that
the downflow area, that the volume of the liquid flowing past on the guide surface (4) is limited by a lip (15) of the diverter block (14) that is disposed at a distance from guide surface (4).

3. The device as cited in claim 1, characterised in that
the diverter block (14) curves over the spillover weir (2).

4. The device as cited in claim 1, characterised in that
the height of the lip (15) of diverter block (14) or of the block (14) as a whole is adjustable (17) for influencing the flow volume.

5. The device as cited in claim 1, in which the liquid collection area is provided at the end of the liquid reservoir opposite the spillover weir and this collection area is formed by multiple liquid inflow apertures distributed across the working width, and which are connected to a number of liquid inflow hoses that are supplied with liquid by a pump, wherein the width of the liquid reservoir is delimited by a comb that extends from the spillover weir to the liquid collection area inside the gap of the liquid reservoir,
characterized in that
the free ends (20) of the comb (18) protrude over the spillover weir (2) to the level of the guide surface (4)

6. The device as cited in claim 5, characterised in that
the free ends (20) of the comb (18) are curved (21) and thus extend over the spillover weir (2) down to the level of the guide surface (4).
